(19) United States
(12) Patent Application Publication
(10) Pub. No.: US 2011/0235183 A1
(43) Pub. Date: Sep. 29, 2011

(54) Grooved lined mirror diffuser

(76) Inventor: William Ahmadi, (US)

(21) Appl. No.: 12/798,001

(22) Filed: Mar. 29, 2010

(51) Int. Cl. G02B 5/02

(52) U.S. Cl. 359/599

(57) ABSTRACT

A grooved lined mirror consists of a mounting substrate of plastic or similar substances whereby the surface is aligned by a plurality of chambers vertically along the substrate. These vertical separations in the substrate produce grooved lines along the perpendicular surface which is affixed by mirror film or poly gal. The substrate can be planar in shape are consist of a plurality of different angled V-shape bends to intensify effect. At least prismatic irregular surfaced sheet acts to diffuse the light reflected from the mirrored surface, thus producing enhanced angle reflected light spectra with a high intensity glow that's projected. The present invention may be applied, but not limited to, lighting, art, signs, edge moldings, shapes, logos, planters, and other surfaces.

### BACKGROUND OF THE INVENTION

1. Field of the Invention

An ambient light disbursement panel relates to the area of light deflection, reflection and diffraction whereby ambient light is broken up into sparkling rays of varying frequencies and colors transmitted from a lined mirrors surface.

2. Background

The use of the decomposition of light is a basic tenant of optical spectroscopy and certain image processing procedures such as photography. Light is either composed of a plurality of frequencies which are transmitted along a focal point for reflection and transmission often using special filters, or a single light beam is broken into a plurality of spectral frequencies for specific uses. The present invention uses the decomposition of light and its reflection and refraction as a lighting source and a decorative source.

3. Prior Art

A reflective substrate including reflectors or mirror elements each having an elongate reflective surface is described in U.S. Pat. No. 7,483,215. A mounting substrate is described whereby its planar surface is spaced apart from grooves upon which an image element is provided. The prior art mentioned above relates to reflective qualities displayed on labels for advertisement. However the present invention incorporates a lined planar surface of a plurality of shapes and sizes whereby at least one side of the substrate is lined with mirrored film and said lines are recessed along said planar surface producing indentations wherein said mirror film is applied. The effect on light is to break individual beams into smaller spectra thereby producing a colorful sparkling radial light effect about the lined mirrors immediate area

### Object

### SUMMARY OF THE INVENTION

The present invention provides light reflecting assemblies and method of producing a plurality of light spectral displays. A lined mounting substrate is covered by a film of mirror or an application of ploy gal on at least one side which in turn provides a lined mirror surface. The lined mirror surface in turn can be covered by a plurality of transparent or translucent planar members of either concave, convex, cube-cornered, crystal ice or crushed ice plastic or glass members whose geometric attributes disperses the dissipated spectral frequencies reflected off said transparent or translucent members surface thereby creating a plurality of light spectra, or haze, of differing frequencies producing a plurality of spectra of differing intensity and or colors.

An object of the present invention and another result of said object is that reflected light surrounding most of the surrounding area is greatly intensified when a planar surfaced prismatic sheet is attached atop the lined mirror substrate. Ambient light passing through said reflective surface, reflected off said mirror through said reflective surface out towards the passing viewers eyes. As a result of the reflection and dispersion of said light the viewer can see a greatly intensified area of light, known as haze, varying depending on the viewers position relative to said lined mirror.

Another object of the present invention is to utilize a lined mirror to gain an angular display of light reflected from said mirrors surface which consists of lines in a v-shape whereby projected and dispersed light is reflected back towards a viewer at three primary angles, directly perpendicular to viewer, to the left greater than 50 degrees but less than 95 degrees, and to the viewers right greater than 50 degrees but less than 95 degrees. Thus light coming from the direction of the viewer's position that reflects directly back to said viewer is less intense than all other angles relative to said linear lined mirror. An angular reflection produces a plurality of broken spectra, which in turn produces vivid colors and luminance about the diameter of the reflective surface.

Drawings

### BRIEF DESCRIPTION OF THE DRAWINGS

FIG. 1 is a multi dimensional slab view of the top, front and side of the lined mirror.

FIG. 2 is a top view of the lined mirror within the surface of a sign.

FIG. 3 is a front two dimensional view of the mounting surface substrate.

FIG. 4 is a top view of another embodiment of the present invention

### DETAILED DESCRIPTION OF THE PREFERRED EMBODIMENT OF THE DRAWINGS

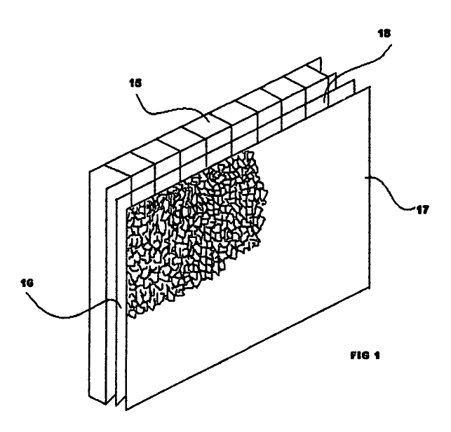

FIG. 1 consists of a multi dimensional angled view of the lined mirror structure called the mounting surface 15, which is a planar, or slight V shaped substrate of plastic aligned vertically. There are two planar shaped surfaces enclosing an interior area of vertical plastic square shaped segments separated by lined grooves 18.

A layer of reflective mirrored film layer 16 is applied to the planar surface of the mounting surface 15 wherein the indentations of the lined grooves 18 align the surface of the Mirror film 16, thus the film acts as a reflector while the lined grooves 18 act to deflect illumination in a plurality of directions angularly producing criss-crossing spectra of multiple frequencies.

In the present embodiment a prismatic planar sheet 17 is placed against, or spaced less than an inch away from the mirrored layered 16 substrate. This acts to disperse said illumination in a plurality of directions and frequencies out toward the viewer. The end result produces a sparkling effect similar to that of a crystallized mirror. The lights geometric attributes are thus dispersed back to the viewer in a highly intensified reflection.

The lined mirrored super reflective structure can be utilized in a plurality of lights, signs, art, edge moldings, shapes, logos and other objects such as planters.

FIG. 2 presents another embodiment of the present invention whereby the grooved lined mirror is incorporated into a sign as a reflector/diffuser. The lined mounting surface 15 from above illustrates a planar surfaced substrate consisting of a plurality of evenly spaced cube like shapes throughout the mounting surface 15. Aligned along the lined mounting surface 15 is a reflective mirror layer 16 whereby the mirrored film 16 becomes grooved and acts to reflect light in an angular specular reflection fashion on either side of a groove. Said mounting surface 15 however can be planar shaped, convex, concave or V shaped.

This embodiment utilizes next a prismatic sheet 17 to diffuse said illumination from said sign through two more bodies. The prismatic sheet 17 has an irregular surface top, its base is planar shaped, and it spans the length of the mounting surface 15 and is attached to the side and upper panels. A translucent, transparent, or milky white lexan sheet 19 is layered next between the prismatic sheet 17 and the film layer 20.

The film layer 20 carries indicia in cut out shapes of letters, numbers, symbols or such.

Thus it is the multi-layered diffusion and reflection system of a sign, according to the present embodiment, that is revealed in FIG. 2 from a top view of the material layering of the sign.

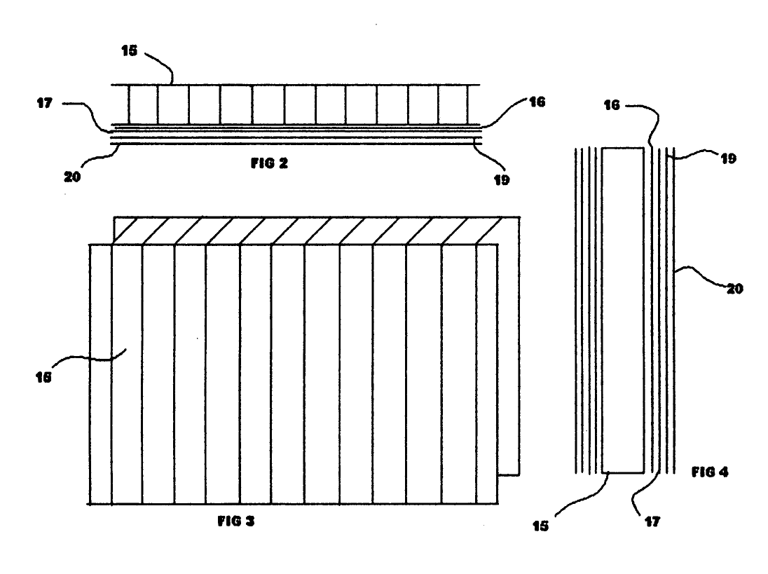

FIG. 3 illustrates the base and backbone of the deflection unit. The mounting surface 15 is sectioned into spaced lined grooves 18 of a rectangular enclosed planar surfaced body. A plurality of vertical dividing panels built into the side walls creates a plurality of square shaped spaces spanning the height of the mounting surface 15. Engraved intersections of squares along the unit's length produce grooved vertical columns along the mounting surface 15.

FIG. 4 is yet another embodiment, and another top view of the sign which consist of the present invention. A top view of the mounting surface 15 lies in the center of this embodiment. Reflective mirror layer consisting of poly gal 16 surrounds both sides of the prismatic sheets 17 whose geometric attributes allows for the dispersion of illumination about the area of the sign. An outer faceplate of a film layer 20 is shaped in a plurality of shapes, letters numbers or symbols. The indented through segments project reflected light outside of the illumination unit. This embodiment is a double sided sign both sides of the sign are described as above.

Other embodiments include single sided signs, such as flat signs, where the facing side includes a mounting surface 15, prismatic sheet 17, a doubled reflective mirror layer 16, a secondary prismatic sheet 17, and a final outer face plate of film layer 20 producing an intense reflected illumination of ambient light which illuminates the sign more efficiently than any standard sign.

### LIST OF DRAWING REFERENCES

15. Mounting surface
16. Reflective mirror layer
17. Prismatic sheet
18. Lined grooves
19. Lexan sheet
20. Film layer/Poly gal

### Conclusions, Ramifications and Scope

While the present invention has been defined in the preferred embodiment, it is understood that numerous modifications and variations of this embodiment will occur to those with ordinary skill in the art. All such modifications and variations shall be deemed to fall within the scope and spirit of the present invention as defined by the appended claims to the invention.

What is claimed is:

1. An ambient light dispersing panel consists of a plurality of substrate sizes and shapes said substrate between said planar surfaces, one a front surface the other a back surface. Said front surface covered with a lined mirror film surface of a plurality of materials producing a lined mirrored substrate. Atop said front surface and lined mirror substrate attached thereto is a planar prismatic sheeting consisting of a plurality of surfaces such as but not limited to crystal ice, crushed ice, cube corners, concave or convex properties where deflected light from said mirror reflects or refracts through said prismatic sheeting creating an angular reflection, and refracting of light with diffusion occurring along some points along the planar prismatic surface.

2. An ambient light dispersing panel according to claim 1, wherein said substrate comprises a lined planar surface having a translucent or transparent appearance consisting of at least two separate planar surfaces connected by means of said substrate.

3. An ambient light dispersing panel according to claim 2, wherein at least one said planar surface comprises a layer of mirrored film or poly gal. Said film filling in the gaps caused by the lined planar surfaces openings, producing lined grooves.

4. An ambient light dispersing panel according to claim 2, wherein said substrate consists of a plurality of evenly spaced squared or rectangular shaped members attached thereto along said front surface and back surface.

5. An ambient light dispersing panel according to claim 2, wherein said substrate comprises a plurality of shaped members evenly spaced attached to said front and back surface.

6. An ambient light dispersing panel according to claim 1, wherein said lined mirror substrate consists of a plurality of depths and angles along a planar surface.

7. An ambient light dispersing panel according to claim 1, wherein said prismatic sheeting consists of a plurality of shapes, sizes and surfaces according to the substrate planar surface size and shape.

8. An ambient light dispersing panel according to claim 7, wherein said prismatic sheeting consists of an uneven top surface and a planar bottom surface.

9. An ambient light dispersing panel according to claim 1, wherein said ambient light disbursement panel reflects, deflects and disperses light at a plurality of specific angles, outwardly towards the viewer along a 180 degree radius creating a direct and broad angular amplification of light.

10. An ambient light disbursement panel according to claim 9, wherein said disbursement panel deflects and disperses light at a plurality of angles by means of a v-like contour along said mirrors lines, whereby light is angularly deflected in a plurality of angles.

11. An ambient light dispersing panel ac cording to claim according to claim 7 wherein a plurality of prismatic sheets are used on either side of a grooved lined mirror in a plurality of applications.
